(19) United States
(12) Patent Application Publication
(10) Pub. No.: US 2022/0126318 A1
(43) Pub. Date: Apr. 28, 2022

(54) METHOD FOR SELECTIVE COATING APPLICATION

(71) Applicant: GM GLOBAL TECHNOLOGY OPERATIONS LLC, Detroit, MI (US)

(72) Inventor: Elke Dieter, Rochester Hills, MI (US)

(73) Assignee: GM GLOBAL TECHNOLOGY OPERATIONS LLC, Detroit, MI (US)

(21) Appl. No.: 17/082,497

(22) Filed: Oct. 28, 2020

(51) Int. Cl. B05D 1/32; B05C 21/00; B05C 3/20

(52) U.S. Cl. CPC B05D 1/32; B05C 3/20; B05C 21/005

(57) ABSTRACT

A method for selective paint application to a component includes applying a photoresist masking to the component and applying a template mask to the component on top of the photoresist masking. The method includes curing at least a portion of the photoresist masking on the component, removing an uncured portion of the photoresist masking from the component, and applying at least one layer of paint to the component. The method further includes removing the photoresist masking from the component.

### INTRODUCTION

The present disclosure relates generally to the application of a coating, such as paint, to selected components or areas of a vehicle, using photo resistant masking.

Photo resistant masking is a process that includes use of a light-sensitive material to form a patterned coating or selective coating on a surface. In the case of positive photo resistant masking, the photosensitive material is degraded by light and a developer dissolves away regions that were exposed to light. In the case of negative photo resistant masking, the photosensitive material is strengthened by light and a developer dissolves regions that were not exposed to light.

### SUMMARY

Embodiments according to the present disclosure provide a number of advantages. For example, embodiments according to the present disclosure enable faster and easier coating application to specific areas of a component.

In one aspect of the present disclosure, a method for selective paint application to a component includes applying a photoresist masking to the component and applying a template mask to the component on top of the photoresist masking. The method includes curing at least a portion of the photoresist masking on the component, removing an uncured portion of the photoresist masking from the component, and applying at least one layer of paint to the component. The method further includes removing the photoresist masking from the component.

In some aspects, applying the photoresist masking to the component includes spraying a photoresist masking material on the component.

In some aspects, applying the template mask to the component includes temporarily securing the template mask to the component on top of the photoresist masking such that at least a portion of the photoresist masking is covered by the template mask.

In some aspects, curing at least a portion of the photoresist masking on the component includes exposing the photoresist masking on the component to ultraviolet light.

In some aspects, removing the uncured portion of the photoresist masking from the component includes removing the template mask from the component and washing the component with a solvent configured to dissolve the uncured portion of the photoresist masking.

In some aspects, applying at least one layer of paint to the component includes spraying at least one layer of paint on the component.

In some aspects, removing the photoresist masking from the component includes washing the component.

In some aspects, removing the photoresist masking from the component includes applying an abrasive material to the component to remove the photoresist masking without damaging at least one layer of paint on the component.

In some aspects, removing the photoresist masking from the component includes removing the photoresist masking by hand.

In some aspects, the template mask is a sheet metal cutout including openings revealing the photoresist masking underneath.

In another aspect of the present disclosure, a system for selectively applying a coating to a component includes a first device configured to apply a photoresist masking to a surface of the component and a mask template configured to be temporarily secured to the surface of the component. The system also includes a second device configured to expose the surface of the component to ultraviolet light such that at least a portion of the photoresist masking on the surface of the component is cured and a third device configured to remove an uncured portion of the photoresist masking from the component. The system also includes a fourth device configured to apply at least one layer of the coating to the component and a fifth device configured to remove a remaining portion of the photoresist masking from the component. The system also includes a controller in electronic communication with the first, second, third, fourth, and fifth devices and configured to control the first, second, third, fourth, and fifth devices according to a painting algorithm.

In some aspects, the first device is a spraying device configured to spray the photoresist masking on the surface of the component.

In some aspects, the second device is at least one ultraviolet light directed at the surface of the component.

In some aspects, the third device is a spraying device configured to cover the surface of the component and dissolve the uncured portion of the photoresist masking from the surface of the component.

In some aspects, the fifth device is an abrasion device configured to abrade the surface of the component to remove the remaining portion of the photoresist masking from the component.

In another aspect of the present disclosure, a method for selectively applying a coating includes providing a component to be coated and applying a photoresist masking to a surface of the component. The method includes temporarily securing a template mask to the component such that the photoresist masking is between the surface of the component and the template mask and curing at least a portion of the photoresist masking applied to the component to create a cured portion of the photoresist masking and an uncured portion of the photoresist masking, the uncured portion of the photoresist masking covered by the template mask. The method includes removing the template mask to expose the cured portion of the photoresist masking and the uncured portion of the photoresist masking, removing the uncured portion of the photoresist masking from the component, applying a layer of paint to the surface of the component, and removing the photoresist masking from the component.

In some aspects, applying the photoresist masking to the surface of the component includes spraying a photoresist masking material on the surface of the component.

In some aspects, curing at least a portion of the photoresist masking applied to the component includes exposing the photoresist masking applied to the component to ultraviolet light.

In some aspects, removing the uncured portion of the photoresist masking from the component includes washing the component with a solvent configured to dissolve the uncured portion of the photoresist masking.

In some aspects, the template mask is a sheet metal cutout including openings revealing the photoresist masking underneath.

### BRIEF DESCRIPTION OF THE DRAWINGS

The present disclosure will be described in conjunction with the following figures, wherein like numerals denote like elements.

FIG. 1A is a schematic illustration of one step of a method for a selective coating application, according to an embodiment.

FIG. 1B is a schematic illustration of one step of a method for a selective coating application, according to an embodiment.

FIG. 1C is a schematic illustration of one step of a method for a selective coating application, according to an embodiment.

FIG. 1D is a schematic illustration of one step of a method for a selective coating application, according to an embodiment.

FIG. 1E is a schematic illustration of one step of a method for a selective coating application, according to an embodiment.

FIG. 2 is a schematic block diagram of a system for a selective coating application, according to an embodiment.

FIG. 3 is a flow chart diagram of a method for a selective coating application, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Photoresist masking is currently used in the electronic industry to remove copper from circuit boards to create the electrical leads on the boards. In other applications, photoresist masking is used to remove glass or stone from components during a carving process. Embodiments discussed herein disclose a use of photoresist masking materials and processes to prevent the application, in selected areas, of a coating, such as paint, on opaque, transparent, or semi-transparent molded plastic components, with and without pre-coated applications. Current processes to remove unwanted paint from these components rely on use of a laser or glue, which are time-consuming methods.

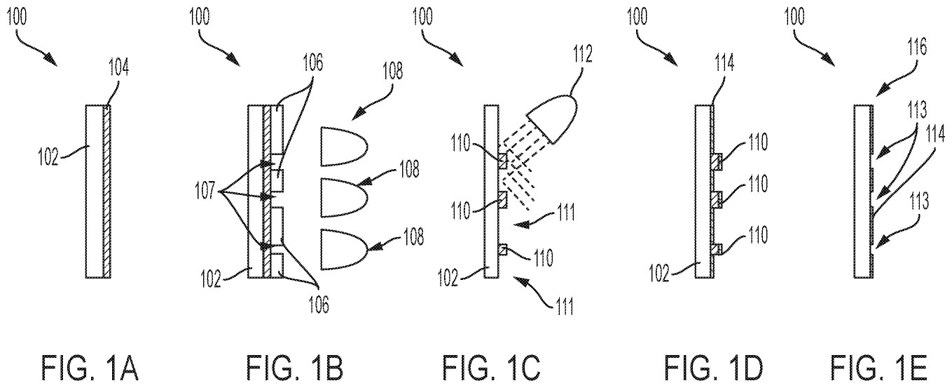

FIGS. 1A-E schematically illustrate a process 100 for selective application of a coating to a component, according to an embodiment. A photoresist masking 104 is applied to a surface of the component 102, as shown in FIG. 1A. In various embodiments, the photoresist masking 104 is sprayed onto the surface of the component 102.

Next, as shown in FIG. 1B, a template mask 106 is applied to the component 102. The template mask 106 is applied on top of the photoresist masking 104 such that the photoresist masking 104 is between the template mask 106 and the surface of the component 102. The template mask 106 includes one or more cutouts or openings 107. The openings 107 allow a portion of the photoresist masking 104 to be exposed. In various embodiments, the template mask 106 is a reusable mask made from cut sheet metal, printed foil, plastic, etc., for example and without limitation.

The combined component 102, photoresist masking 104, and template mask 106 construction is then exposed to a light source, such as one or more ultraviolet lights 108. The ultraviolet light cures the exposed portions of the photoresist masking 104, that is, the portions of the photoresist masking 104 that are aligned with the openings 107 in the template mask 106. The template mask 106 is then removed, leaving behind cured and uncured portions of the photoresist masking 104 on the component 102.

As shown in FIG. 1C, the component 102 is washed via a washout process, illustrated by a washing mechanism 112. The washout process includes applying a solvent to the component 102 that dissolves the uncured portions of the photoresist masking 104, leaving behind the cured portions 110 of the photoresist masking 104. The cured portions 110 of the photoresist masking 104 remain adhered to the surface of the component 102 throughout the washing process while the uncured portions are removed, leaving behind one or more exposed surface areas 111 of the component 102. In various embodiments, the washing mechanism 112 is one or more sprayers that sprays the solvent on the component 102.

The component 102 is then dried, and a coating, such as paint 114, is applied to the entire surface of the component 102, as shown in FIG. 1D. The paint 114 is applied to the exposed surface areas 111 of the component 102, as well as over the cured portions 110 of the photoresist masking 104.

Finally, as shown by FIG. 1E, the cured portions 110 of the photoresist masking 104 are removed from the surface of the component 102. The removal process leaves behind exposed surface areas 113 of the surface of the component 102 that were covered by the photoresist masking 104. In various embodiments, the exposed surface areas 113 correspond to transparent or other areas for which paint coverage is not desired.

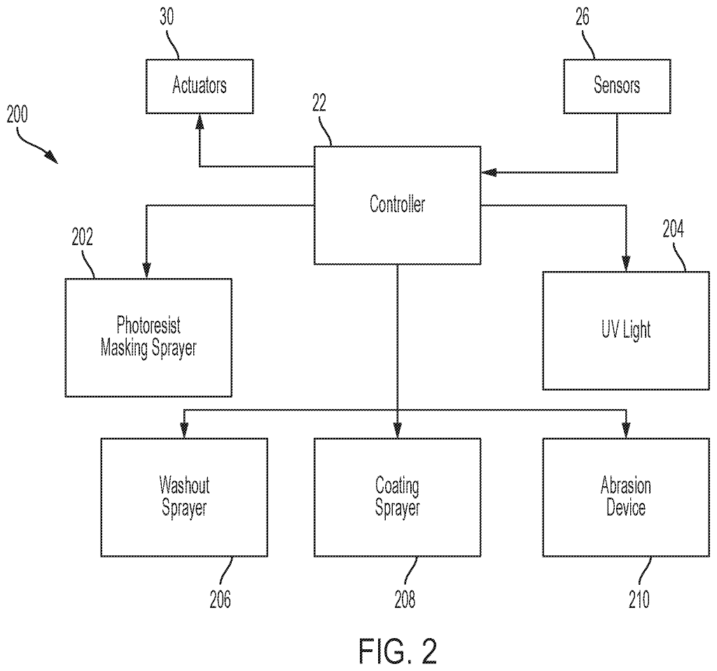

In various embodiments, the process 100 is completed by various machines, robots, sensors, actuators, etc., for example and without limitation. In some embodiments, as shown in FIG. 2, a system 200 includes a controller 22 in electronic communication with various mechanisms or devices configured to perform the process 100. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22.

The controller 22 is in electronic communication with one or more sensors 26 and one or more actuators 30. The sensors 26 provide data regarding the component location, shape, or orientation, for example and without limitation. The actuators 30 receive instructions from the controller 22 performing a painting algorithm to perform various functions including control of a painting robot or device, abrasion robot or device, or other automated mechanism, for example and without limitation. In various embodiments, the controller 22 generates one or more control signals to control the various machines used to perform the process 100. The controller 22 controls a first device such as a photoresist masking sprayer 202, a second device such as an ultraviolet light 204, a third device such as a washout sprayer 206, a fourth device such as a coating sprayer 208, and a fifth device such as an abrasion device 210. While FIG. 2 illustrates various mechanized and/or automated devices configured to perform one or more of the steps of the process 100, in various embodiments, one or more of the steps of the process 100 illustrated in FIGS. 1A-E may be performed manually.

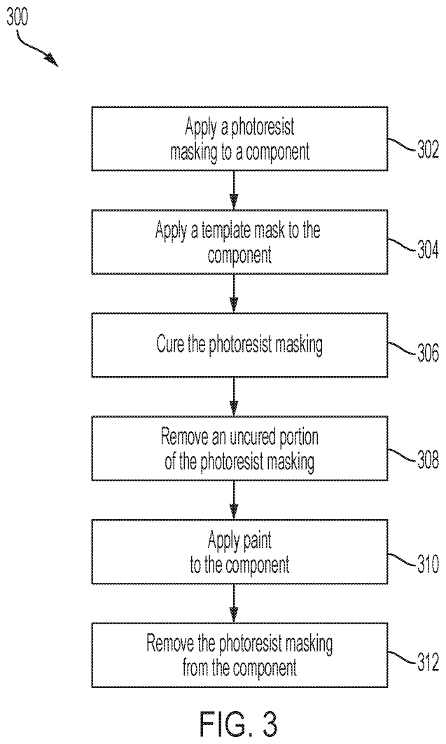

FIG. 3 illustrates a method 300 to selectively apply a coating, such as paint, to a component. The method 300 can be utilized in connection with the system 200. The order of operation of the method 300 is not limited to the sequential execution as illustrated in FIG. 3, but may be performed in one or more varying orders, or steps may be performed simultaneously, as applicable in accordance with the present disclosure.

First, at 302, a photoresist masking is applied to a surface of a component, such as the component 102. The photoresist masking is applied to the component using the first device such as the photoresist masking sprayer 202, in various embodiments. Next, at 304, a template mask is removably secured to the component over the photoresist masking layer. That is, the template mask can be removed from the surface of the component without damaging the component or the photoresist masking. The template mask includes one or more openings to allow a portion of the photoresist masking to be exposed.

At 306, the photoresist masking is cured, using, in some embodiments, an ultraviolet light source such as the ultraviolet light 204. The ultraviolet light cures the portion or portions of the photoresist masking that are exposed, while the portion or portions of the photoresist masking that are covered by the template mask remain uncured. Next, at 308, the uncured portion or portions of the photoresist masking is removed. This removal process is accomplished, in some embodiments, by washing or spraying the component 102 with a solvent configured to dissolve the uncured portion or portions of the photoresist masking. The solvent is applied, in some embodiments, by the washout sprayer 206.

At 310, a coating, such as paint, is applied to the surface of the component 102, including over the cured portion or portions of the photoresist masking. In various embodiments, the coating is applied by the coating sprayer 208. This allows for a straightforward application of paint to the component 102. Finally, at 312, the remaining cured portions of the photoresist masking are removed from the component 102. In various embodiments, this removal is achieved by abrasion, washing, pulling, or other removal methods. In various embodiments, the removal of the remaining cured portions of the photoresist masking are removed by hand, while in some embodiments, the removal is accomplished by a machine either controlled by an operator or by the controller 22, such as the abrasion device 210.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to he performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic parameter, or value need not be achieved exactly, but that deviations or variations, including for example, tolerances, measurement error, measurement accuracy limitations and other factors known to those of skill in the art, may occur in. amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for selective paint application to a component, comprising:
applying a photoresist masking to the component;
applying a template mask to the component on top of the photoresist masking;
curing at least a portion of the photoresist masking on the component;
removing an uncured portion of the photoresist masking from the component;
applying at least one layer of paint to the component; and
removing the photoresist masking from the component.

2. The method of claim 1, wherein applying the photoresist masking to the component comprises spraying a photoresist masking material on the component.

3. The method of claim 1, wherein applying the template mask to the component comprises temporarily securing the template mask to the component on top of the photoresist masking such that at least a portion of the photoresist masking is covered by the template mask.

4. The method of claim 1, wherein curing at least the portion of the photoresist masking on the component comprises exposing the photoresist masking on the component to ultraviolet light.

5. The method of claim 1, wherein removing the uncured portion of the photoresist masking from the component comprises removing the template mask from the component and washing the component with a solvent configured to dissolve the uncured portion of the photoresist masking.

6. The method of claim 1, wherein applying the at least one layer of paint to the component comprises spraying the at least one layer of paint on the component.

7. The method of claim 1, wherein removing the photoresist masking from the component comprises washing the component.

8. The method of claim 1, wherein removing the photoresist masking from the component comprises applying an abrasive material to the component to remove the photoresist masking without damaging the at least one layer of paint on the component.

9. The method of claim 1, wherein removing the photoresist masking from the component comprises removing the photoresist masking by hand.

10. The method of claim 1, wherein the template mask is a sheet metal cutout including openings revealing the photoresist masking underneath.

11. A system for selectively applying a coating to a component, comprising:
a first device configured to apply a photoresist masking to a surface of the component;
a mask template configured to be temporarily secured to the surface of the component;
a second device configured to expose the surface of the component to ultraviolet light such that at least a portion of the photoresist masking on the surface of the component is cured;
a third device configured to remove an uncured portion of the photoresist masking from the component;
a fourth device configured to apply at least one layer of the coating to the component;
a fifth device configured to remove a remaining portion of the photoresist masking from the component; and
a controller in electronic communication with the first, second, third, fourth, and fifth devices and configured to control the first, second, third, fourth, and fifth devices according to a painting algorithm.

12. The system of claim 11, wherein the first device is a spraying device configured to spray the photoresist masking on the surface of the component.

13. The system of claim 11, wherein the second device is at least one ultraviolet light directed at the surface of the component.

14. The system of claim 11, wherein the third device is a spraying device configured to cover the surface of the component and dissolve the uncured portion of the photoresist masking from the surface of the component.

15. The system of claim 11, wherein the fifth device is an abrasion device configured to abrade the surface of the component to remove the remaining portion of the photoresist masking from the component.

16. A method for selectively applying a coating, comprising:
providing a component to be coated;
applying a photoresist masking to a surface of the component;
temporarily securing a template mask to the component such that the photoresist masking is between the surface of the component and the template mask;
curing at least a portion of the photoresist masking applied to the component to create a cured portion of the photoresist masking and an uncured portion of the photoresist masking, the uncured portion of the photoresist masking covered by the template mask;
removing the template mask to expose the cured portion of the photoresist masking and the uncured portion of the photoresist masking;
removing the uncured portion of the photoresist masking from the component;
applying a layer of paint to the surface of the component; and
removing the photoresist masking from the component.

17. The method of claim 16, wherein applying the photoresist masking to the surface of the component comprises spraying a photoresist masking material on the surface of the component.

18. The method of claim 16, wherein curing at least the portion of the photoresist masking applied to the component comprises exposing the photoresist masking applied to the component to ultraviolet light.

19. The method of claim 16, wherein removing the uncured portion of the photoresist masking from the component comprises washing the component with a solvent configured to dissolve the uncured portion of the photoresist masking.

20. The method of claim 16, wherein the template mask is a sheet metal cutout including openings revealing the photoresist masking underneath.
